(19) United States
(12) Patent Application Publication
(10) Pub. No.: US 2013/0304373 A1
(43) Pub. Date: Nov. 14, 2013

(54) NAVIGATION METHOD, NAVIGATION SYSTEM AND MAP DATA DOWNLOADING METHOD FOR NAVIGATION

(71) Applicants: Tsai-Yuan Kuo, New Taipei City (TW); Lian-Chih Chen, New Taipei City (TW); Chia-Ming Liang, New Taipei City (TW); Chi-Fa Huang, New Taipei City (TW)

(72) Inventors: Tsai-Yuan Kuo, New Taipei City (TW); Lian-Chih Chen, New Taipei City (TW); Chia-Ming Liang, New Taipei City (TW); Chi-Fa Huang, New Taipei City (TW)

(21) Appl. No.: 13/563,751

(22) Filed: Aug. 1, 2012

(30) Foreign Application Priority Data
May 11, 2012 (TW) 101116849

(51) Int. Cl. G01C 21/34; G01C 21/26

(52) U.S. Cl. 701/412; 701/409; 701/428; 701/461; 701/451

(57) ABSTRACT

A navigation method includes steps of calculating a first coordinate of a first position; taking the first coordinate to be a center of a predetermined range and calculating a first map data within the predetermined range according to a zoom scale of a map scale; downloading the first map data from a map server; storing the first map data; using the first map data to render a first graphic user interface map corresponding to the first coordinate; and displaying the first graphic user interface map.

### BACKGROUND OF THE INVENTION

1. Field of the Invention

The invention relates to a navigation method and a navigation system and, more particularly, to a map data downloading method capable of reducing a capacity required for storing map data for navigation effectively.

2. Description of the Prior Art

As global position system (GPS) and various mobile devices (e.g. smart phone) advance and develop, navigation function performed on mobile devices has been improved and diversified accordingly. So far there have been lots of mobile devices with built-in navigation software, which uses a path routing software engine with built-in map data to calculate an optimal path so as to guide a user to a destination according to the optimal path. However, the aforesaid mobile devices with navigation function usually have some problems as follows: first, map data cannot be updated regularly so that out-of-date map data does not match real road condition; secondly, since map data, which is usually very huge, has to be stored in the mobile device in advance, it is necessary to add additional system memory capacity for storing the map data; and thirdly, the navigation precision is not good so that the mobile device cannot identify a direction in time when the user makes a turn at an intersection.

### SUMMARY OF THE INVENTION

The invention provides a navigation method, a navigation system and a map data downloading method for navigation, so as to solve the aforesaid problems.

According to the claimed invention, a navigation method comprises steps of calculating a first coordinate of a first position; taking the first coordinate to be a center of a predetermined range and calculating a first map data within the predetermined range according to a zoom scale of a map scale; downloading the first map data from a map server; storing the first map data; using the first map data to render a first graphic user interface map corresponding to the first coordinate; and displaying the first graphic user interface map.

According to the claimed invention, the navigation method further comprises steps of calculating a second coordinate of a second position when the first position moves to the second position; taking the second coordinate to be the center of the predetermined range and calculating a second map data within the predetermined range according to the zoom scale of the map scale; downloading the second map data from the map server; replacing the first map data by the second map data; using the second map data to render a second graphic user interface map corresponding to the second coordinate; updating the first graphic user interface map by the second graphic user interface map; and displaying the second graphic user interface map.

According to the claimed invention, the navigation method further comprises steps of selecting whether to execute a navigation indicating mode; setting a starting point and a destination point after selecting to execute the navigation indicating mode; calculating an optimal path between the starting point and the destination point by a path calculation algorithm; and displaying an indicator relative to the optimal path in the first graphic user interface map.

According to the claimed invention, the navigation method further comprises steps of determining whether a moving path deviates from the optimal path; and recalculating the optimal path by the path calculation algorithm when the moving path deviates from the optimal path.

According to the claimed invention, the path calculation algorithm comprises an A* algorithm and a balanced tree algorithm.

According to the claimed invention, a navigation system comprises a communication module for communicating with a map server; a positioning module for calculating a first coordinate of a first position; a map loading module for taking the first coordinate to be a center of a predetermined range and calculating a first map data within the predetermined range according to a zoom scale of a map scale and then downloading the first map data from the map server through the communication module; a storage module for storing the first map data; a map rendering module for using the first map data to render a first graphic user interface map corresponding to the first coordinate; and a display module for displaying the first graphic user interface map.

According to the claimed invention, the positioning module calculates a second coordinate of a second position when the first position moves to the second position; the map loading module takes the second coordinate to be the center of the predetermined range and calculates a second map data within the predetermined range according to the zoom scale of the map scale, downloads the second map data from the map server through the communication module, and replaces the first map data in the storage module by the second map data; the map rendering module uses the second map data to render a second graphic user interface map corresponding to the second coordinate and updates the first graphic user interface map by the second graphic user interface map; the display module displays the second graphic user interface map.

According to the claimed invention, the navigation system further comprises a path routing module for calculating an optimal path between a starting point and a destination point by a path calculation algorithm and displaying an indicator relative to the optimal path in the first graphic user interface map.

According to the claimed invention, the path routing module recalculates the optimal path by the path calculation algorithm when a moving path deviates from the optimal path.

According to the claimed invention, the path calculation algorithm comprises an A* algorithm and a balanced tree algorithm.

According to the claimed invention, the navigation system further comprises a gyro for cooperating with the positioning module to calculate the first coordinate.

According to the claimed invention, the navigation system further comprises a g-sensor for cooperating with the positioning module to calculate the first coordinate.

According to the claimed invention, a map data downloading method for navigation comprises steps of calculating a first coordinate of a first position; taking the first coordinate to be a center of a predetermined range and calculating a first map data within the predetermined range according to a zoom scale of a map scale; downloading the first map data from a map server; and storing the first map data.

According to the claimed invention, the map data downloading method for navigation further comprises steps of calculating a second coordinate of a second position when the first position moves to the second position; taking the second coordinate to be the center of the predetermined range and calculating a second map data within the predetermined range according to the zoom scale of the map scale; downloading the second map data from the map server; and replacing the first map data by the second map data.

As mentioned in the above, after the positioning module calculates a coordinate of a current position, the map loading module will take the coordinate to be the center of the predetermined range and calculate a map data within the predetermined range according to the zoom scale of the map scale and then downloads the map data from the map server through the communication module. After the position changes from one to another, the map loading module will take a new coordinate to be the center of the predetermined range and calculate a new map data within the predetermined range according to the zoom scale of the map scale again, downloads the new map data from the map server through the communication module, and replaces the old map data by the new map data. In other words, the invention only downloads partial map data from the map server according to the current position of a user rather than downloading and storing full map data into the storage module. Accordingly, the invention can reduce the capacity required for storing map data effectively so as to save hardware. Furthermore, the map loading module may take a new coordinate to be the center of the predetermined range and calculate a new map data within the predetermined range according to the zoom scale of the map scale every a period of time (e.g. every three seconds, every five seconds, etc.) so as to update the map data dynamically and ensure that the map data matches real road condition. Moreover, the invention may use the gyro and/or the g-sensor to cooperate with the positioning module to calculate the coordinate of the current position so as to enhance the navigation precision.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a navigation system according to an embodiment of the invention.

FIG. 2 is a flowchart illustrating a map data downloading method for navigation according to an embodiment of the invention.

FIG. 3 is a schematic diagram illustrating a first map data within a predetermined range taking a first coordinate to be a center thereof.

FIG. 4 is a schematic diagram illustrating a first graphic user interface map displayed on the display module.

FIG. 5 is a schematic diagram illustrating a second map data within the predetermined range taking a second coordinate to be the center thereof.

FIG. 6 is a schematic diagram illustrating a second graphic user interface map displayed on the display module.

FIGS. 7A to 7C are flowcharts illustrating a navigation method according to an embodiment of the invention.

### DETAILED DESCRIPTION

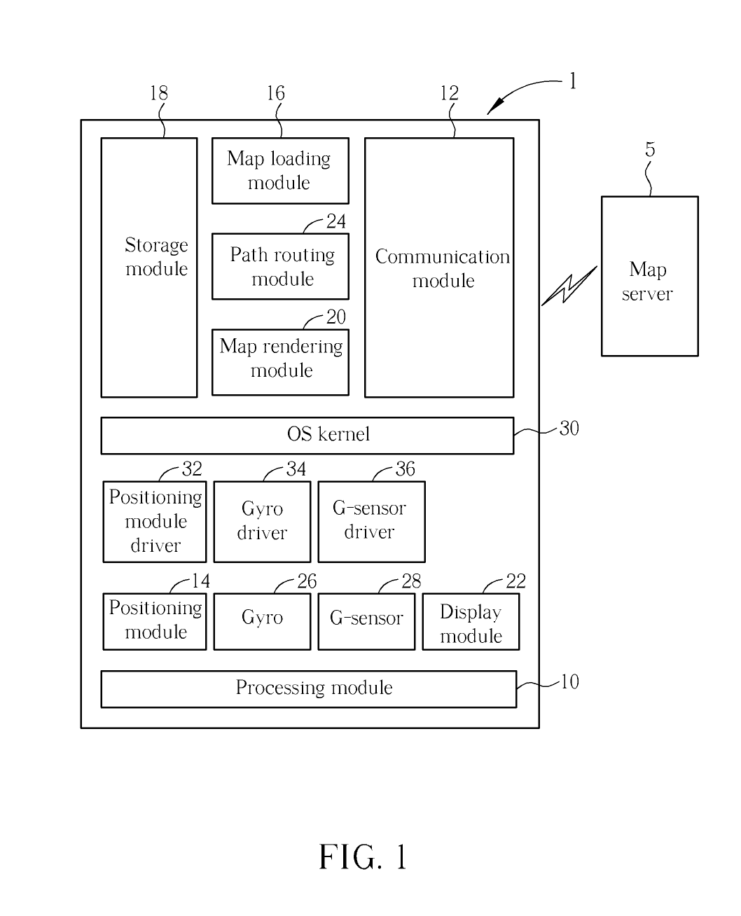

Referring to FIG. 1, FIG. 1 is a functional block diagram illustrating a navigation system 1 according to an embodiment of the invention. As shown in FIG. 1, the navigation system 1 comprises a processing module 10, a communication module 12, a positioning module 14, a map loading module 16, a storage module 18, a map rendering module 20, a display module 22, a path routing module 24, a gyro 26, a g-sensor 28, a operating system (OS) kernel 30, a positioning module driver 32, a gyro driver 34 and a g-sensor driver 36.

In practical applications, the navigation system 1 may be a smart phone, a navigation device or other electronic devices with satellite positioning function and communication function; the processing module 10 may be a central processing unit (CPU); the communication module 12 may be Bluetooth, WiFi, 3G or other wireless communication modules; the positioning module 14 may be a GPS module or other satellite positioning modules; the storage module 18 may be a flash memory or other devices capable of storing data; and the display module 22 may be a liquid crystal display (LCD) device or other display devices. In general, the navigation system 1 may be equipped with some necessary hardware or software components for specific purposes, such as a power supply, an operating system, an antenna, etc., and it depends on practical applications.

The map loading module 16, the map rendering module 20 and the path routing module 24 can be implemented by software. The principle of the OS kernel 30 is well known by one skilled in the art and will not be depicted herein. The positioning module driver 32 is used for driving the positioning module 14, the gyro driver is used for driving the gyro 34, and the g-sensor driver 36 is used for driving the g-sensor 28.

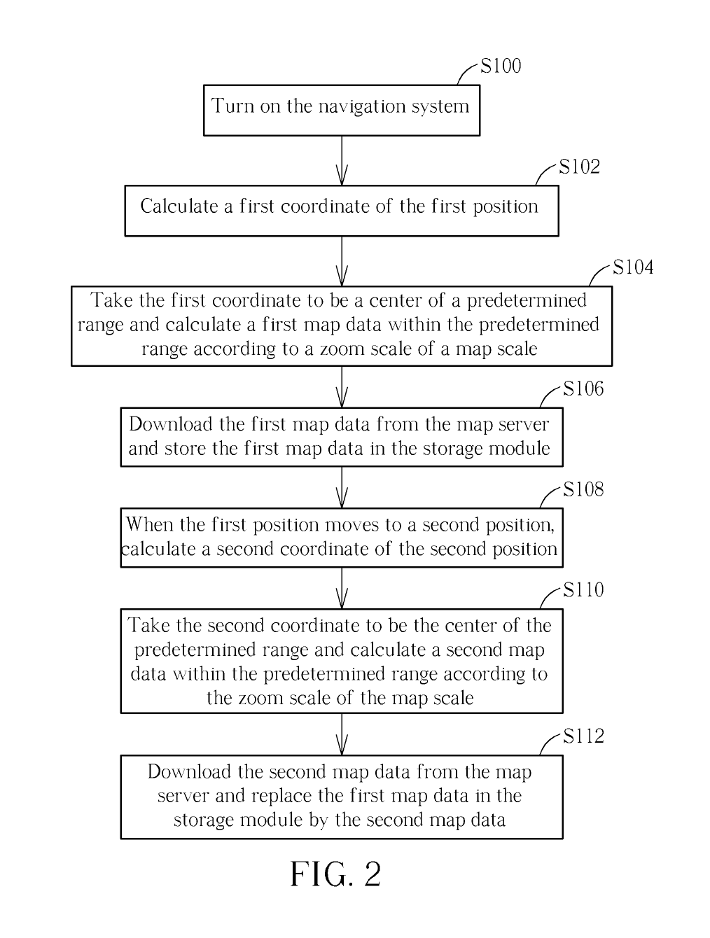

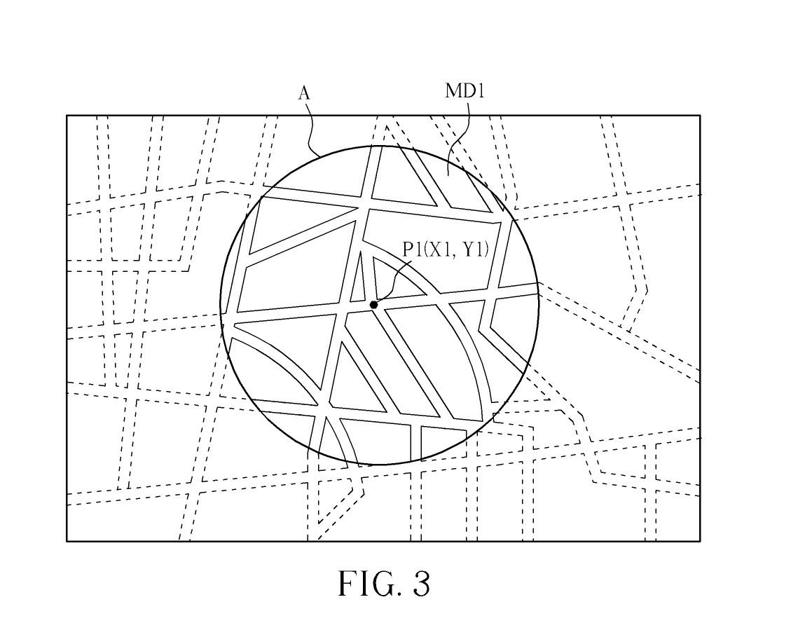

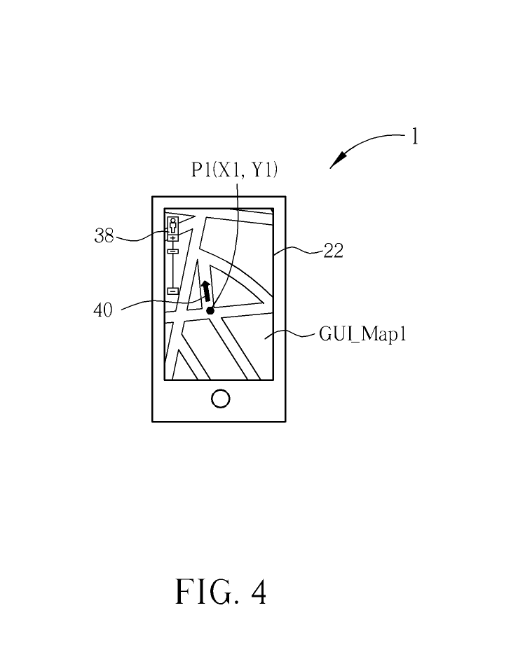

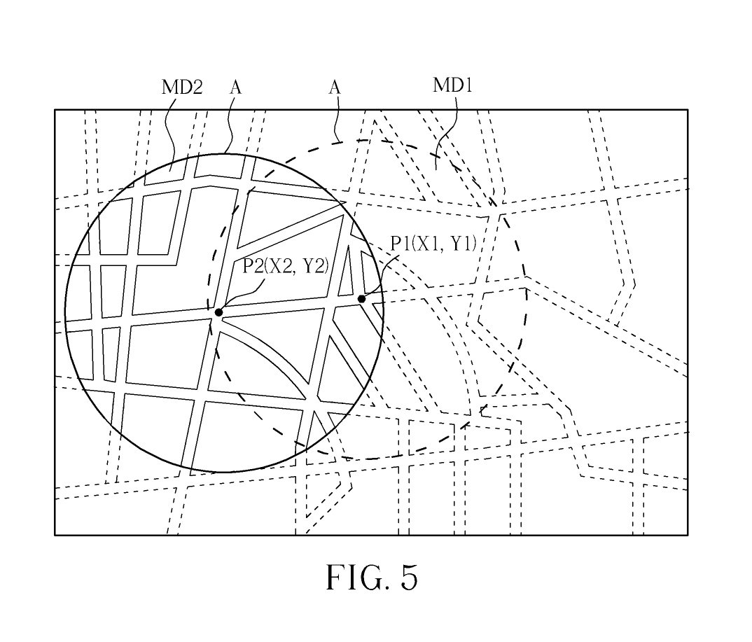

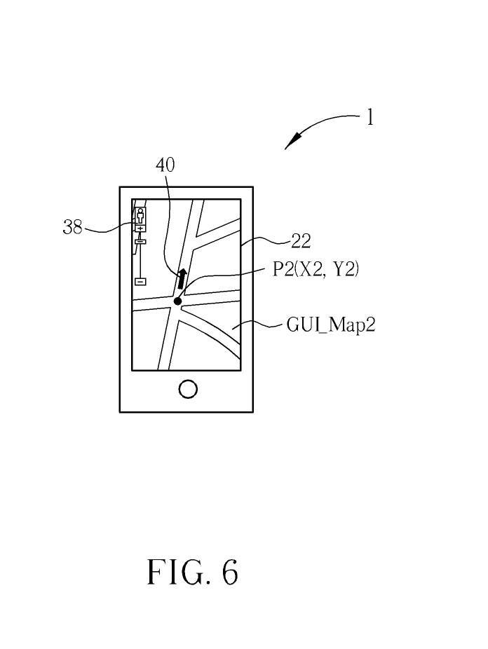

Referring to FIGS. 2 to 6, FIG. 2 is a flowchart illustrating a map data downloading method for navigation according to an embodiment of the invention, FIG. 3 is a schematic diagram illustrating a first map data MD1 within a predetermined range A taking a first coordinate (X1, Y1) to be a center thereof, FIG. 4 is a schematic diagram illustrating a first graphic user interface map GUI_Map1 displayed on the display module 22, FIG. 5 is a schematic diagram illustrating a second map data MD2 within the predetermined range A taking a second coordinate (X2, Y2) to be the center thereof, and FIG. 6 is a schematic diagram illustrating a second graphic user interface map GUI_Map2 displayed on the display module 22, wherein the map data downloading method shown in FIG. 2 can be implemented by the navigation system 1 shown in FIG. 1.

As shown in FIG. 1, the communication module 12 of the navigation system 1 communicates with a map server 5. The map server 5 may be an on-line electronic map provider, such as google map, urmap, Yahoo! Map, and so on. As shown in FIG. 3, when a user turns on the navigation system 1 at a first position P1 (step S100 in FIG. 2), the positioning module 14 receives a satellite positioning signal and calculates a first coordinate (X1, Y1) of the first position P1 according to the satellite positioning signal (step S102 in FIG. 2). Afterward, the map loading module 16 takes the first coordinate (X1, Y1) to be a center of a predetermined range A and calculates a first map data MD1 within the predetermined range A according to a zoom scale of a map scale 38 (as shown in FIG. 4 and step S104 in FIG. 2). Then, the map loading module 16 downloads the first map data MD1 from the map server 5 through the communication module 12 and stores the first map data MD1 in the storage module 18 (step S106 in FIG. 2). In this embodiment, the zoom scale of the map scale 38 can be adjusted by the user based on his/her demand. Furthermore, the predetermined range A can be determined based on practical applications. For example, the predetermined range A may be, but not limited to, an area covering a circumference of one hundred kilometers, which takes the first coordinate (X1, Y1) to be the center.

As shown in FIG. 5, when the user carries the navigation system 1 and moves from the first position P1 to a second position P2, the positioning module 14 will calculate a second coordinate (X2, Y2) of the second position P2 according to the satellite positioning signal (step S108 in FIG. 2). Afterward, the map loading module 16 takes the second coordinate (X2, Y2) to be the center of the predetermined range A and calculates a second map data MD2 within the predetermined range A according to the zoom scale of the map scale 38 (step S110 in FIG. 2). Then, the map loading module 16 downloads the second map data MD2 from the map server 5 through the communication module 12 and replaces the first map data MD1 in the storage module 18 by the second map data MD2 (step S112 in FIG. 2).

Therefore, after the position changes from one to another, the map loading module 16 will take a new coordinate (i.e. the aforesaid second coordinate (X2, Y2)) to be the center of the predetermined range A and calculate a new map data (i.e. the aforesaid second map data MD2) within the predetermined range A according to the zoom scale of the map scale 38 again, downloads the new map data from the map server 5 through the communication module 12, and replaces the old map data (i.e. the aforesaid first map data MD1) by the new map data. In other words, the invention only downloads partial map data (i.e. the aforesaid first map data MD1 or second map data MD2) from the map server 5 according to the current position of a user (i.e. the aforesaid first position P1 or second position P2) rather than downloading and storing full map data into the storage module 18. Accordingly, the invention can reduce the capacity required for storing map data effectively so as to save hardware. Furthermore, the map loading module 16 may take a new coordinate to be the center of the predetermined range A and calculate a new map data within the predetermined range A according to the zoom scale of the map scale 38 every a period of time (e.g. every three seconds, every five seconds, etc.) so as to update the map data dynamically and ensure that the map data matches real road condition.

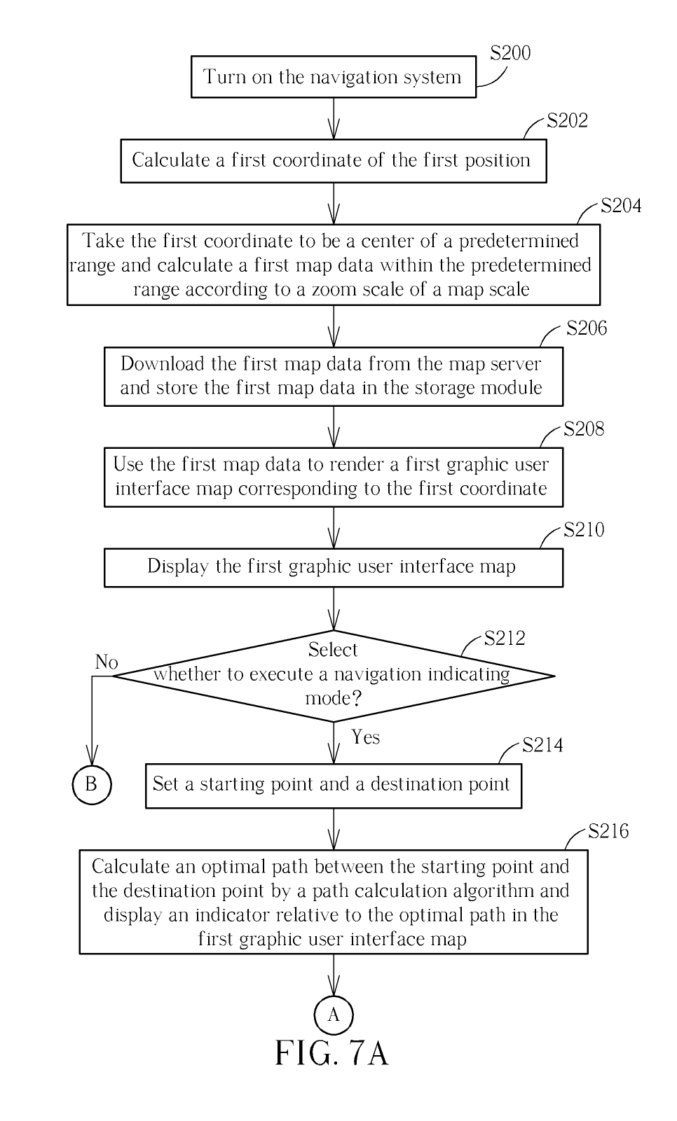

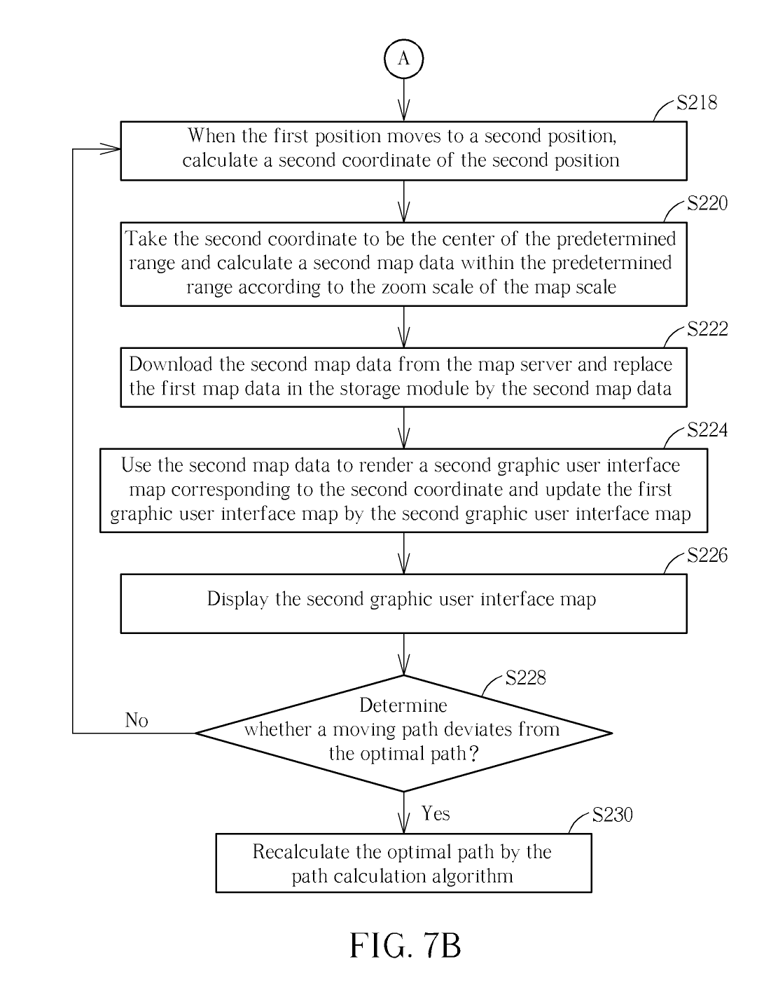

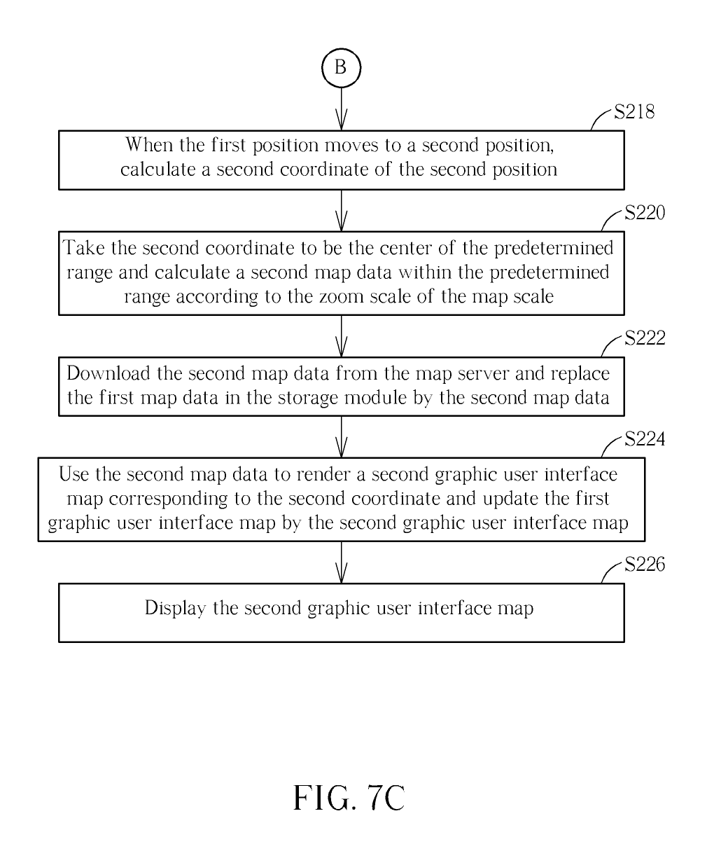

Referring to FIGS. 7A to 7C, FIGS. 7A to 7C are flowcharts illustrating a navigation method according to an embodiment of the invention. The navigation method shown in FIGS. 7A to 7C can be implemented by the navigation system 1 shown in FIG. 1. It should be noted that the steps S200-S206 shown in FIG. 7A are the same as the steps S100-S106 shown in FIG. 2 and will not be depicted herein again. After storing the first map data MD1 in the storage module 18 (step S206 in FIG. 7A), the map rendering module 20 will use the first map data MD1 to render a first graphic user interface map GUI_Map1 corresponding to the first coordinate (X1, Y1) (step S208 in FIG. 7A) and then the display module 22 will display the first graphic user interface map GUI_Map1 (step S210 in FIG. 7A), as show in FIG. 4. Afterward, the user can operate an input device (e.g. touch panel, button, and so on) of the navigation system 1 to select whether to execute a navigation indicating mode (step S212 in FIG. 7A). After selecting to execute the navigation indicating mode, the user has to operate the input device to set a starting point and a destination point (step S214 in FIG. 7A). Then, the path routing module 24 calculates an optimal path between the starting point and the destination point by a path calculation algorithm and displays an indicator 40 relative to the optimal path in the first graphic user interface map GUI_Map1 (step S216 in FIG. 7A), as shown in FIG. 4. At this time, the user can follow a direction indicated by the indicator 40 to move forward so as to arrive the destination point. In this embodiment, the aforesaid path calculation algorithm may comprise, but not limited to, an A* algorithm and a balanced tree (B-Tree) algorithm. It should be noted that the principles of the A* algorithm and the balanced tree algorithm are well known by one skilled in the art and will not be depicted herein.

As mentioned in the above, when the user carries the navigation system 1 and moves from the first position P1 to the second position P2, the map loading module 16 will replace the first map data MD1 in the storage module 18 by the second map data MD2 (steps S218-S222 in FIGS. 7B and 7C). It should be noted that the steps S218-S222 shown in FIGS. 7B and 7C are the same as the steps S108-S112 shown in FIG. 2 and will not be depicted herein again.

After storing the second map data MD2 in the storage module 18, the map rendering module 20 will use the second map data MD2 to render a second graphic user interface map GUI_Map2 corresponding to the second coordinate (X2, Y2) and update the first graphic user interface map GUI_Map1 by the second graphic user interface map GUI_Map2 (step S224 in FIG. 7B), such that the display module 22 will display the second graphic user interface map GUI_Map2 (step S226 in FIG. 7B), as show in FIG. 6. At this time, the aforesaid indicator 40 is still displayed in the second graphic user interface map GUI_Map2, as shown in FIG. 6.

The processing module 10 will determine whether a moving path of the user deviates from the optimal path continuously when the user is moving (step S228 in FIG. 7B). When the moving path of the user deviates from the optimal path, the path routing module 24 will recalculate the optimal path by the aforesaid path calculation algorithm (step S230 in FIG. 7B). On the other hand, if the moving path of the user does not deviate from the optimal path, step S218 will be performed again till the user arrives the destination point.

If the user selects not to execute the navigation indicating mode in the aforesaid step S212, steps S218-S226 will be performed immediately (as shown in FIG. 7C). At this time, the aforesaid indicator 40 will not be displayed in the first graphic user interface map GUI_Map1 and the second graphic user interface map GUI_Map2.

In this embodiment, the invention may use the gyro 26 and/or the g-sensor 28 to cooperate with the positioning module 14 to calculate the coordinate of the current position (e.g. the aforesaid first coordinate (X1, Y1) of the first position P1 and the aforesaid second coordinate (X2, Y2) of the second position P2) so as to enhance the navigation precision.

In this embodiment, the positioning module 14, the gyro 26 and the g-sensor 28 are built in the navigation system 1. However, in another embodiment, the positioning module 14, the gyro 26 and the g-sensor 28 may be integrated into one single electronic device cooperated with the navigation system 1 so as to achieve the aforesaid functions.

Furthermore, the control logic of the map data downloading method shown in FIG. 2 and the navigation method shown in FIGS. 7A to 7C can be implemented by software. The software can be executed in any electronic devices with data processing function, such as smart phone, navigation device or other electronic devices with satellite positioning function and communication function. Needless to say, each part or function of the control logic may be implemented by software, hardware or the combination thereof. Moreover, the control logic of the map data downloading method shown in FIG. 2 and the navigation method shown in FIGS. 7A to 7C can be embodied by a computer readable storage medium, wherein the computer readable storage medium stores instructions, which can be executed by an electronic device so as to generate control command for executing corresponding function.

As mentioned in the above, after the positioning module calculates a coordinate of a current position, the map loading module will take the coordinate to be the center of the predetermined range and calculate a map data within the predetermined range according to the zoom scale of the map scale and then downloads the map data from the map server through the communication module. After the position changes from one to another, the map loading module will take a new coordinate to be the center of the predetermined range and calculate a new map data within the predetermined range according to the zoom scale of the map scale again, downloads the new map data from the map server through the communication module, and replaces the old map data by the new map data. In other words, the invention only downloads partial map data from the map server according to the current position of a user rather than downloading and storing full map data into the storage module. Accordingly, the invention can reduce the capacity required for storing map data effectively so as to save hardware. Furthermore, the map loading module may take a new coordinate to be the center of the predetermined range and calculate a new map data within the predetermined range according to the zoom scale of the map scale every a period of time (e.g. every three seconds, every five seconds, etc.) so as to update the map data dynamically and ensure that the map data matches real road condition. Moreover, the invention may use the gyro and/or the g-sensor to cooperate with the positioning module to calculate the coordinate of the current position so as to enhance the navigation precision.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A navigation method comprising:
calculating a first coordinate of a first position;
taking the first coordinate to be a center of a predetermined range and calculating a first map data within the predetermined range according to a zoom scale of a map scale;
downloading the first map data from a map server;
storing the first map data;
using the first map data to render a first graphic user interface map corresponding to the first coordinate; and
displaying the first graphic user interface map.

2. The navigation method of claim 1, further comprising:
calculating a second coordinate of a second position when the first position moves to the second position;
taking the second coordinate to be the center of the predetermined range and calculating a second map data within the predetermined range according to the zoom scale of the map scale;
downloading the second map data from the map server;
replacing the first map data by the second map data;
using the second map data to render a second graphic user interface map corresponding to the second coordinate;
updating the first graphic user interface map by the second graphic user interface map; and
displaying the second graphic user interface map.

3. The navigation method of claim 1, further comprising:
selecting whether to execute a navigation indicating mode;
setting a starting point and a destination point after selecting to execute the navigation indicating mode;
calculating an optimal path between the starting point and the destination point by a path calculation algorithm; and
displaying an indicator relative to the optimal path in the first graphic user interface map.

4. The navigation method of claim 3, further comprising:
determining whether a moving path deviates from the optimal path; and
recalculating the optimal path by the path calculation algorithm when the moving path deviates from the optimal path.

5. The navigation method of claim 3, wherein the path calculation algorithm comprises an A* algorithm and a balanced tree algorithm.

6. A navigation system comprising:
a communication module for communicating with a map server;
a positioning module for calculating a first coordinate of a first position;
a map loading module for taking the first coordinate to be a center of a predetermined range and calculating a first map data within the predetermined range according to a zoom scale of a map scale and then downloading the first map data from the map server through the communication module;
a storage module for storing the first map data;
a map rendering module for using the first map data to render a first graphic user interface map corresponding to the first coordinate; and
a display module for displaying the first graphic user interface map.

7. The navigation system of claim 6, wherein the positioning module calculates a second coordinate of a second position when the first position moves to the second position; the map loading module takes the second coordinate to be the center of the predetermined range and calculates a second map data within the predetermined range according to the zoom scale of the map scale, downloads the second map data from the map server through the communication module, and replaces the first map data in the storage module by the second map data; the map rendering module uses the second map data to render a second graphic user interface map corresponding to the second coordinate and updates the first graphic user interface map by the second graphic user interface map; the display module displays the second graphic user interface map.

8. The navigation system of claim 6, further comprising a path routing module for calculating an optimal path between a starting point and a destination point by a path calculation algorithm and displaying an indicator relative to the optimal path in the first graphic user interface map.

9. The navigation system of claim 8, wherein the path routing module recalculates the optimal path by the path calculation algorithm when a moving path deviates from the optimal path.

10. The navigation system of claim 8, wherein the path calculation algorithm comprises an A* algorithm and a balanced tree algorithm.

11. The navigation system of claim 6, further comprising a gyro for cooperating with the positioning module to calculate the first coordinate.

12. The navigation system of claim 6, further comprising a g-sensor for cooperating with the positioning module to calculate the first coordinate.

13. A map data downloading method for navigation comprising:
calculating a first coordinate of a first position;
taking the first coordinate to be a center of a predetermined range and calculating a first map data within the predetermined range according to a zoom scale of a map scale;
downloading the first map data from a map server; and
storing the first map data.

14. The map data downloading method for navigation of claim 13, further comprising:
calculating a second coordinate of a second position when the first position moves to the second position;
taking the second coordinate to be the center of the predetermined range and calculating a second map data within the predetermined range according to the zoom scale of the map scale;
downloading the second map data from the map server; and
replacing the first map data by the second map data.
